(19) United States
(12) Patent Application Publication
(10) Pub. No.: US 2023/0385265 A1
(43) Pub. Date: Nov. 30, 2023

(54) DATA LAKE WITH TRANSACTIONAL SEMANTICS

(71) Applicant: VMware, Inc., Palo Alto, CA (US)

(72) Inventors: Christos KARAMANOLIS, Los Gatos, CA (US); Abhishek GUPTA, San Jose, CA (US); Richard P. SPILLANE, Palo Alto, CA (US); Marin NOZHCHEV, Sofia (BG)

(21) Appl. No.: 17/827,795

(22) Filed: May 30, 2022

(51) Int. Cl. G06F 16/23; G06F 16/22; G06F 11/14

(52) U.S. Cl. CPC G06F 16/2365; G06F 16/2282; G06F 11/1435

(57) ABSTRACT

A version control interface provides for accessing a data lake with transactional semantics. Examples generate a plurality of tables for data objects stored in the data lake. The tables each comprise a set of name fields and map a space of columns or rows to a set of the data objects. Transactions read and write data objects and may span a plurality of tables with properties of atomicity, consistency, isolation, durability (ACID). Performing the transaction comprises: accumulating transaction-incomplete messages, indicating that the transaction is incomplete, until a transaction-complete message is received, indicating that the transaction is complete. Upon this occurring, a master branch is updated to reference the data objects according to the transaction-incomplete messages and the transaction-complete message. Tables may be grouped into data groups that provide atomicity boundaries so that different groups may be served by different master branches, thereby improving the speed of master branch updates.

### BACKGROUND

A data lake is a popular storage abstraction used by the emerging class of data-processing applications. Data lakes are typically implemented on scale-out, low-cost storage systems or cloud services, which allow for storage to scale independently of computing power. Unlike traditional data warehouses, data lakes provide bare-bones storage features in the form of files or objects and may support open storage formats. They are typically used to store semi-structured and unstructured data. Files (objects) may store table data in columnar and/or row format. Metadata services, often based on open source technologies, may be used to organize data in the form of tables, somewhat similar to databases, but with less stringent schema. Essentially, the tables are maps from named aggregates of fields to dynamically changing groups of files (objects). Data processing platforms use the tables to locate the data and implement access and queries.

The relatively low cost, scalability, and high availability of data lakes, however, come at the price of high latencies, weak consistency, lack of transactional semantics, inefficient data sharing, and a lack of useful features such as snapshots, clones, version control, time travel, and lineage tracking. These shortcomings, and others, create challenges in the use of data lakes by applications. For example, the lack of support for cross-table transactions restricts addressable query use cases, and high write latency performance negatively impacts real-time analytics.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure provide solutions for improving access to data in a data lake. Example operations include: generating a plurality of tables for data objects stored in the data lake, wherein each table comprises a set of name fields and maps a space of columns or rows to a set of the data objects; and performing a transaction comprising writing data objects spanning a plurality of tables, wherein the transaction has properties of atomicity, consistency, isolation, durability (ACID), and wherein performing the transaction comprises: accumulating transaction-incomplete messages, indicating that the transaction is incomplete, until a transaction-complete message is received, indicating that the transaction is complete; and based on at least receiving the transaction-complete message, updating a master branch referencing the data objects according to the transaction-incomplete messages and the transaction-complete message.

### BRIEF DESCRIPTION OF THE DRAWINGS

The present description will be better understood from the following detailed description read in the light of the accompanying drawings, wherein:

FIG. 1 illustrates an example architecture that advantageously provides a version control interface, along with a read/write interface and a write-ahead log, that are used in conjunction with the version control interface for accessing a data lake;

FIGS. 2A and 2B illustrate examples of branches including a master branch with multiple point-in-time snapshots of its state, as may be used by the architecture of FIG. 1;

FIG. 3 illustrates an example data partitioning structure, as may be used by the architecture of FIG. 1;

FIG. 4 illustrates example generation of a private branch from a master branch, as may occur when using the architecture of FIG. 1;

FIG. 5 illustrates example concurrent writing to private branches by a plurality of writers while concurrently reading from a master branch, as may occur when using the architecture of FIG. 1;

FIGS. 6A and 6B illustrate an example of sequentially merging private branches back into the master branch, as may occur when using the architecture of FIG. 1;

FIG. 7 illustrates a flowchart of exemplary operations associated with examples of the architecture of FIG. 1;

FIG. 8 illustrates using a buffer to store messages for a transaction, using examples of the architecture of FIG. 1;

FIG. 9 illustrates the use of data groups in examples of the architecture of FIG. 1;

FIG. 10 illustrates the flow of data through various components of the architecture of FIG. 1;

FIG. 11 illustrates another flowchart of exemplary operations associated with examples of the architecture of FIG. 1;

FIG. 12 illustrates another flowchart of exemplary operations associated with examples of the architecture of FIG. 1; and

FIG. 13 illustrates a block diagram of a computing apparatus that may be used as a component of the architecture of FIG. 1, according to an example.

### DETAILED DESCRIPTION

Aspects of the disclosure permit multiple readers and writers (e.g., clients) to access one or more data lakes concurrently at least by providing a layer of abstraction between the client and the data lake that acts as an overlay file system. The layer of abstraction is referred to, in some examples, as a version control interface for data. An example version control interface for data is a set of software components (e.g., computer-executable instructions), application programming interfaces (APIs), and/or user interfaces (UIs) that may be used to manage access (e.g., read and/or write) to data by a set of clients. One goal of such an interface is to implement well-defined semantics that facilitate the coordinated access to the data, capture the history of updates, perform conflict resolution, and other operations. A version control interface (for data) allows the implementation of higher-level processes and workflows, such as transactions, data lineage tracking, and data governance. Some of the examples are described in the context of a version control interface for data lakes in particular, but other examples are within the scope of the disclosure.

Concurrency control coordinates access to the data lake to ensure a consistent version of data such that all readers read consistent data and metadata, even while multiple writers are writing into the data lake. Access to the data is performed using popular and/or open protocols. Examples of such protocols include protocols that are compatible with AWS S3, Hadoop Distributed File System interface (HDFS), NFS v3 and v4, etc. In a similar fashion, access to metadata services that are used to store metadata (e.g., maps from tables to files or objects) is compatible with popular and/or open interfaces, for example the Hive Metastore Interface (HMS) API. The terms object, data object, and file are used interchangeably herein.

Common query engines may be supported, while also enabling efficient batch and streaming analytics workloads. Federation of multiple heterogeneous storage systems is supported, and data and metadata paths may be scaled independently and dynamically, according to evolving workload demands. Transactional atomicity, consistency, isolation, and durability (ACID) semantics may be provided using optimistic concurrency control, which also provides versioning, and lineage tracking for data governance functions. This facilitates tracing the lifecycle of the data from source through modification (e.g., who performed the modification, and when).

In some examples, this is accomplished by leveraging branches, which are isolated namespaces that are super-imposed on data objects (files) that constitute tables. Reads are serviced using a master branch (also known as a public branch), while data is written (e.g., ingested as a stream from external data sources) using multiple private branches. Aspects of the disclosure improve the reliability and management of computing operations at least by creating a private branch for each writer, and then generating a new master branch for the data stored in a data lake by merging the private branch into a new master branch. Readers then read the data objects from the data lake using references in the new master branch.

In some examples, a master branch is a long-lived branch (e.g., existing for years, or indefinitely). The master branch includes a set (e.g., list) of snapshots, each of which obey conflict resolution policies in place at the time the snapshot was taken. The snapshots may be organized in order of creation. A private branch is a fork from the master branch to facilitate read and/or write operations in an isolated way. A private branch may also act as a write buffer for streaming data. Private branches are often short-lived, existing for the duration of the execution of some client-driven workflow, e.g., a number of operations or transactions, before being merged back into the master branch.

To write to the data lake, whether in bulk (e.g., ingest streams of large number of rows) or individual operation (e.g., a single row or a few rows), a writer checks out a private branch and may independently create or write data objects in that branch. That data does not become visible to other clients (e.g., other writers and readers). Once a user determines that enough data is written to the private branch (or based on resource pressure or a timer event, as described herein), the new data is committed, which finalizes it in the private branch. Even after a commit, the new data remain visible only in the writer's private branch. Readers have access only to a public master branch. To ensure correctness, a merging process occurs from the private branches to the master branch thus allowing the new data to become publicly visible in the master branch. This enables a consistent and ordered history of writes.

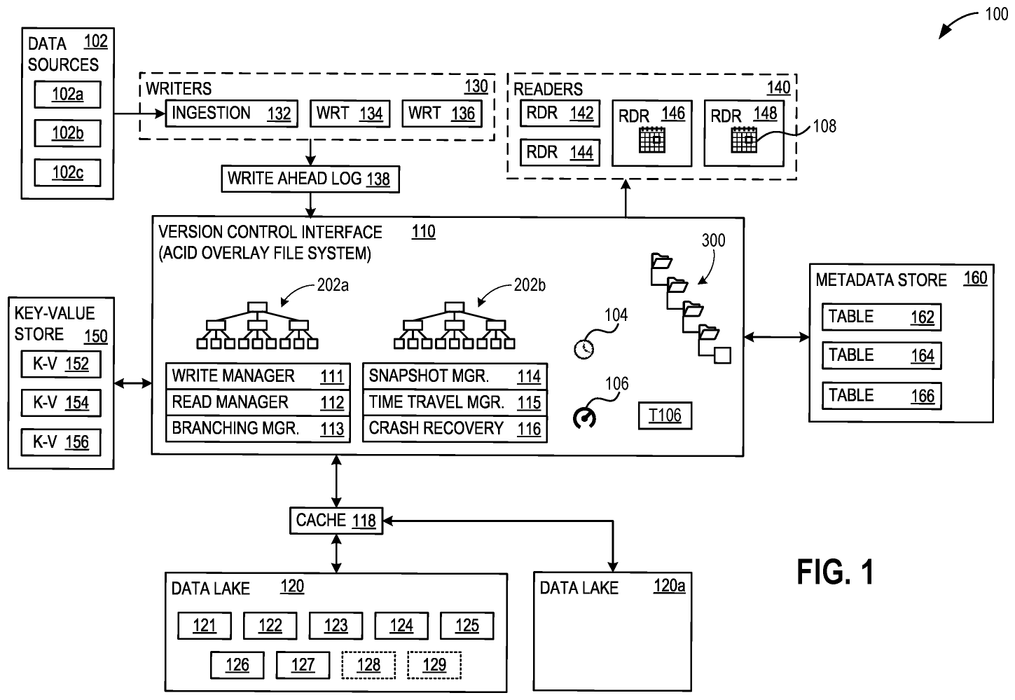

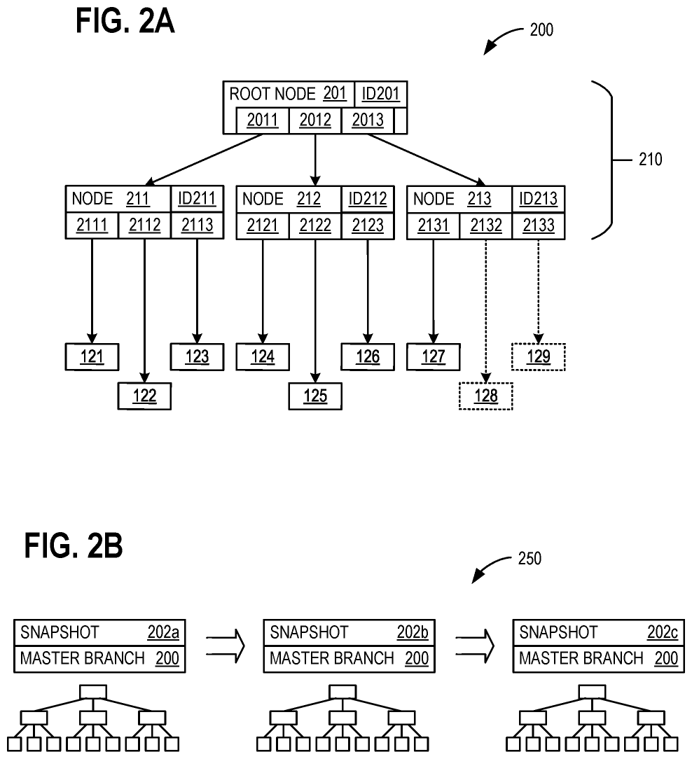

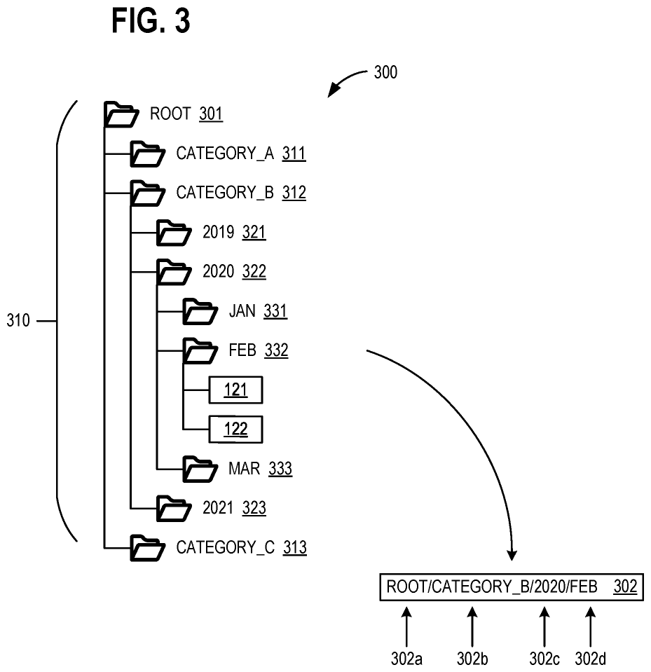

FIG. 1 illustrates an architecture 100 that advantageously improves access to data lakes with a version control interface 110 (e.g., a file overlay system) for accessing a data lake 120. In some examples, version control interface 110 overlay multiple data stores, providing data federation (e.g., a process that allows multiple data stores to function as a single data lake). A write manager 111 and a read manager 112 provide a set of application programming interfaces (APIs) for coordinating access by a plurality of writers 130 and a plurality of readers 140. Writers 130 and readers 140 include, for example, processes that write and read, respectively, data to/from data lake 120. Version control interface 110 leverages a key-value (K-V) store 150 and a metadata store 160 for managing access to the master branch, as described in further detail below. A master branch 200 is illustrated and described in further detail in relation to FIG. 2A, and a notional data partitioning structure 300, representing the hierarchical namespace of the overlay file system, is illustrated and described in further detail in relation to FIG. 3.

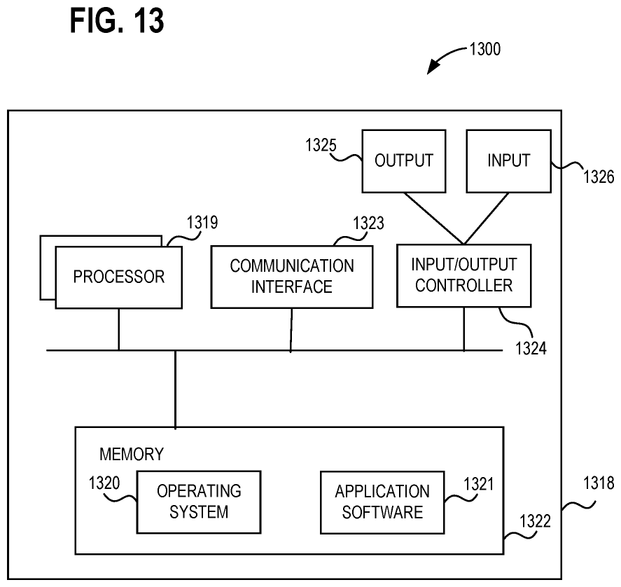

In some examples, architecture 100 is implemented using a virtualization architecture, which may be implemented on one or more computing apparatus 1318 of FIG. 13. An example computing framework on which the components of FIG. 1 may be implemented and executed uses a combination of virtual machines, containers, and serverless computing abstractions. Example storage on which the data lake may be implemented is a cloud storage service, or a hardware/software system. The storage can be a file system or an object storage system.

Data lake 120 holds multiple data objects, illustrated at data objects 121-129. Data objects 128 and 129 are shown with dotted lines because they are added to data lake 120 at a later time by writer 134 and writer 136, respectively. Data lake 120 also ingests data from data sources 102, which may be streaming data sources, via an ingestion process 132 that formats incoming data as necessary for storage in data lake 120. Data sources 102 is illustrated as comprising a data source 102a, a data source 102b, and a data source 102c. Data objects 121-129 may be structured data (e.g., database records), semi-structured (e.g., logs and telemetry), or unstructured (e.g., pictures and videos).

Inputs and outputs are handled in a manner that ensures speed and reliability. Writers 130, including ingestion process 132, writer 134, and writer 136, leverage a write ahead log (WAL) 138 for crash resistance, which in combination with the persistence properties of the data lake storage, assists with the durability aspects of ACID. The WAL 138 is a data structure where write operations are persisted in their original order of arrival to the system. It is used to ensure transactions are implemented even in the presence of failures. In some examples, WAL 138 is implemented using Kafka.

For example, in the event of a crash (e.g., software or hardware failure), crash recovery 116 may replay WAL 138 to reconstruct messages. WAL 138 provides both redo and undo information, and also assists with atomicity. In some examples, version control interface 110 uses a cache 118 to interface with data lake 120 to speed up operations (or multiple data lakes 120, when version control interface 110 is providing data federation). Write manager 111 manages writing objects (files to data lake 120. Although write manager 111 is illustrated as a single component, it may be implemented using a set of distributed functionality, similarly to other illustrated components of version control interface 110 (e.g., read manager 112, branching manager 113, snapshot manager 114, time travel manager 115, and crash recovery 116).

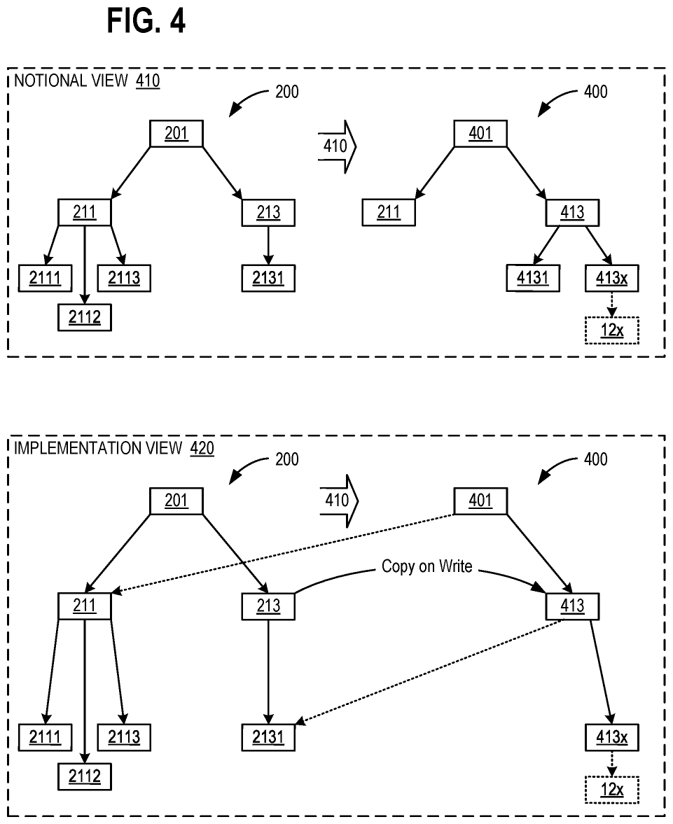

A metadata store 160 organizes data (e.g., data objects 121-129) into tables, such as a table 162, table 164, and a table 166. Tables 162-166 may be stored in metadata store 160 and/or on servers (see FIG. 4) hosting an implementation of version control interface 110. A table provides a hierarchical namespace, typically organized by a default partitioning policy of some of the referenced data attributes, e.g., the date (year/month/day) of the data creation, as indicated for data partitioning structure 300 in FIG. 3. For example, a partition holds data objects created in a specific day. In either case, the database is accessible through a standard open protocol. For example, if one of readers 140 performs a query using a structured query language (SQL) statement that performs a SELECT over a range of dates, then the organization of data partitioning structure 300 indicates the appropriate directories and data objects in the overlay file system to locate the partitions from which to read objects.

A table is a collection of files (e.g., a naming convention that indicates a set of files at a specific point in time), and a set of directories in a storage system. In some examples, tables are structured using a primary partitioning scheme, such as time (e.g., date, hour, minutes), and directories are organized according to the partitioning scheme. In an example of using a timestamp for partitioning, an interval is selected, and incoming data is timestamped. At the completion of the interval, all data coming in during the interval is collected into a common file. Other organization, such as data source, data user, recipient, or another, may also be used, in some examples. This permits rapid searching for data items by search parameters that are reflected in the directory structure.

Data may be written in data lake 120 in the form of transactions. This ensures that all of the writes that are part of a transaction are manifested at the same time (e.g., available for reading by others), so that either all of the data included in the transaction may be read by others (e.g., a completed transaction) or none of the data in the transaction may be read by others (e.g., an aborted transaction). Atomicity guarantees that each transaction is treated as a single unit, which either succeeds completely, or fails completely. Consistency ensures that a transaction can only transition data from one valid state to another. Isolation ensures that concurrent execution of transactions leaves the data in the same state that would have been obtained if the transactions were executed sequentially. Durability ensures that once a transaction has been committed, the results of the transaction (its writes) will persist even in the case of a system failure (e.g., power outage or crash). Optimistic concurrency control assumes that multiple transactions can frequently complete without interfering with each other.

Isolation determines how transaction integrity is visible to other users and systems. A lower isolation level increases the ability of many users to access the same data at the same time, although also increases the number of concurrency effects (such as dirty reads or lost updates) users might encounter. Conversely, a higher isolation level reduces the types of concurrency effects that users may encounter, but typically requires more system resources and increases the chances that one transaction will block another. Isolation is commonly defined as a property that determines how or when changes made by one operation become visible to others.

There are four common isolation levels, each stronger than those below, such that no higher isolation level permits an action forbidden by a lower isolation level. This scheme permits executing a transaction at an isolation level stronger than that requested. The isolation levels, in some examples, include (from highest to lowest): serializable, repeatable reads, read committed, and read uncommitted.

Tables 162-166 may be represented using a tree data structure 210 of FIG. 2A. Turning briefly to FIG. 2A, a master branch 200 comprises a root node 201, which is associated with an identifier ID201, and contains references 2011-2013 to lower nodes 211-213. The identifiers, such as identifier ID201 are any universally unique identifiers (UUIDs). One example of a UUID is a content-based UUID. A content-based UUID has an added benefit of content validation. An example of an overlay data structure that uses content-based UUIDs is a Merkle tree, although any cryptographically unique ID is suitable. Aspects of the disclosure are operable with any UUID, and are not limited to Merkle trees, hash values, or other content-based UUIDs. The data structures implement architecture 100 (the ACID overlay file system) of FIG. 1. The nodes of the data structures are each uniquely identified by a UUID, which may be hash based. In the case where the hash is that of the content of the node, the data structure may be a Merkle tree.

If content-based UUIDs are used, then a special reclamation process is required to delete nodes that are not referenced anymore by any nodes in the tree. Nodes may be metadata nodes or actual data objects (files/objects) in the storage. Such reclamation process uses a separate data structure, such as a table, to track the number of references to each node in the tree. When updating the tree, including with a copy-on-write method, the table entry for each affected node has to be updated atomically with the changes to the tree. When a node A is referenced by a newly created node B, then the reference count for node A in the table is incremented. When a node B that references node A is deleted, for example because the only snapshot where node B exists is deleted, then the reference count of node A in the table is decremented. A node is deleted from storage when its reference count in the table drops to zero.

In an overlay file system that uses content-based UUIDs for the data structure nodes (e.g., a Merkle tree), identifier ID201 comprises the hash of root node 201, which contains the references to nodes 211-213. Node 211, which is associated with an identifier ID211, has reference 2111, reference 2112, and reference 2113 (e.g., addresses in data lake 120) to data object 121, data object 122, and data object 123, respectively. In some examples, identifier ID211 comprises a hash value of the content of the node, which includes references 2111-2113. For example, in intermediate nodes, the contents are the references to other nodes. The hash values may also be used for addressing the nodes in persistent storage. Those skilled in the art will note that the identifiers need not be derived from content-based hash values but could be randomly generated, while still content-based hash values in the nodes may be used for data verification purposes.

Node 212, which is associated with an identifier ID212, has reference 2121, reference 2122, and reference 2123 (e.g., addresses in data lake 120) to data object 124, data object 125, and data object 126, respectively. In some examples, identifier ID212 comprises a hash value of references 2121-2133. Node 213, which is associated with an identifier ID213, has reference 2131, reference 2132, and reference 2133 (e.g., addresses in data lake 120) to data object 127, data object 128, and data object 129, respectively. In some examples, identifier ID213 comprises a hash value of references 2131-2133. In some examples, each node holds a component of the name space path starting from the table name (see FIG. 3). Nodes are uniquely identifiable by their hash value (e.g., identifiers ID201-ID213). In some examples, tree data structure 210 comprises a Merkle tree, which is useful for identifying changed data, and facilitates versioning and time travel. However, aspects of disclosure are operable with other forms of tree data structure 210. Further, the disclosure is not limited to hash-only IDs (e.g., Merkel tree). However, hashes may be stored for verification.

The tree data structure 210 may be stored in the data lake or in a separate storage system. That is, the objects that comprise the overlaid metadata objects do not need to be stored in the same storage system as the data itself. For example, the tree data structure 210 may be stored in a relational database or key-value store.

Master branch 200 is a relational designation indicating that other branches (e.g., private branches, see FIG. 4) are copied from it and merged back into it. In some examples, a merge process iterates through new files, changed files, and deleted files in the private branch, relative to what had been in master branch when the merging private branch had been forked, to identify changes. The merging process also identifies changes made to the master branch (e.g., comparing the current master branch with the version of the master branch at the time of forking) concurrently with changes happening in a private branch. For all of the identified changes, the files (data objects) are compared to the files at the same paths in master branch 200 to determine if a conflict exists. If there is a conflict, a conflict resolution solution is implemented. Aspects of the disclosure are operable with multiple conflict resolution policies. Example conflict resolution policies include, but are not limited to, the following: always accepting changes from the private branch; forbidding the merge and requesting that the private branch rebase (abort and retry: refork and reapply changes to the current master branch) for conflicts; and reading files from one private branch and writing them to another private branch. The present application is not limited to these example conflict resolution policies, and is operable with other policies, algorithms, strategies, and solutions. Some examples employ more than one of these conflict resolution solutions and select a specific solution on a per-transaction basis.

Since master branch 200 is constantly changing, various versions are captured in snapshots, as shown in FIG. 2B. A snapshot is a set of reference markers for data at a particular point in time. In relation to master branch 200, a snapshot is an immutable copy of the tree structure, whereas a branch (e.g., a private branch of FIG. 4) is a mutable copy. A snapshot is uniquely identified by its unique root node for that instance. Each snapshot acts as an immutable point-in-time view of the data. A history of snapshots may be used to provide access to data as of different points in time and may be used to access data as it existed at a certain point in time (e.g., rolled back in time).

To enable concurrent readers and writers, snapshots are used to create branches. Some examples use three types of branches: a master branch (only one exists at a time) that is used for reading both data and metadata at a consistent point in time, a private branch (multiple may exist concurrently) that acts as a write buffer for streaming transactions and excludes other readers, and a workspace branch (multiple may exist concurrently) that facilitates reads and writes for certain transactions. The master branch is updated atomically only by merging committed transactions from the other two types of branches. Readers use either the master branch to read committed data or a workspace branch to read in the context of an ongoing transaction. Writers use either a private branch or a workspace branch to write, depending on the type of workload, ingestion, or transactions respectively. Private and workspace branches may be instantiated as snapshots of the master branch by copying the root node of the tree (e.g., the base). In some examples, writers use copy-on-write (CoW) to keep the base immutable for read operations (Private branches) and for merging. CoW is a technique to efficiently create a copy of a data structure without time consuming and expensive operations at the moment of creating the copy. If a unit of data is copied but not modified, the “copy” may exist merely as a reference to the original data, and only when the copied data is modified is a physical copy created so that new bytes may be written to memory or storage.

FIG. 2B shows an example in which a master branch 200 passes through three versions, with a snapshot created for each version. The active master branch 200 is also mutable, as private branches are merged into the current master branch. Merging involves incorporating new nodes and data from a private branch into the master branch, replacing equivalent nodes (having old contents), adding new nodes, and/or deleting existing nodes. However, there are multiple snapshots of master branch 200 through which the evolution of the data over time may be tracked. Read operations that are not part of a transaction may be served from a snapshot of the master branch. Typically, reads are served from the most recent master branch snapshot, unless the read is targeting an earlier version of the data (e.g., time travel). A table may comprise multiple files that are formatted for storing a set of tuples, depending on the partitioning scheme and lifetime of a private branch. In some examples, a new file is created when merging a private branch. A read may be serviced using multiple files, depending on the time range on the read query. In some examples, parquet files are used. In some examples, a different file format is used, such as optimized row columnar (ORC), or Avro.

Master branch snapshot 202a is created for master branch 200, followed by a master branch snapshot 202b, which is then followed by a master branch snapshot 202c. Master branch snapshots 202a-202c reflect the content of master branch 200 at various times, in a linked list 250, and are read-only. Linked list 250 provides tracking data lineage, for example, for data policy compliance. In some examples, a data structure other than a linked list may be used to capture the history and dependencies of branch snapshots. In some examples, mutable copies of a branch snapshot may be created that can be used for both reads and writes. Some examples store an index of the linked list in a separate data base or table in memory to facilitate rapid queries on time range, modified files, changes in content, and other search criteria.

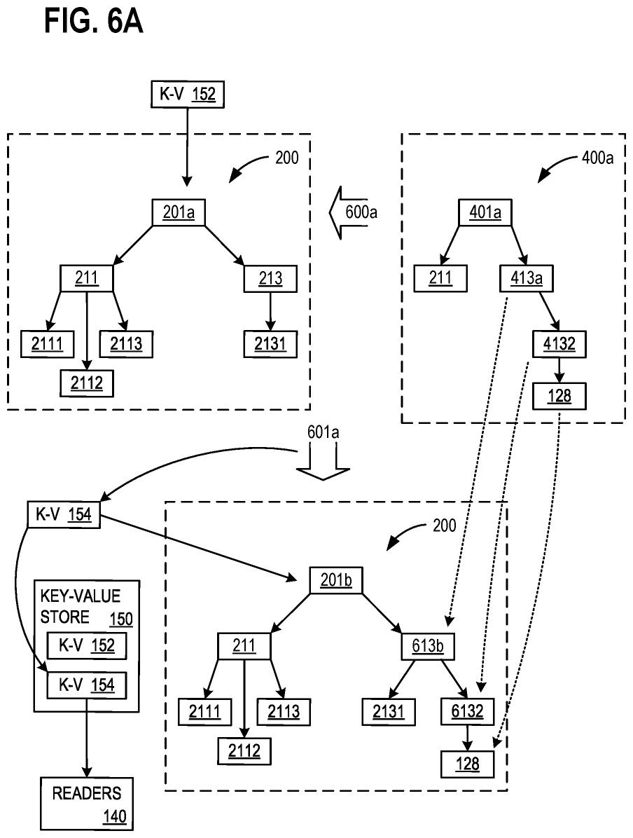

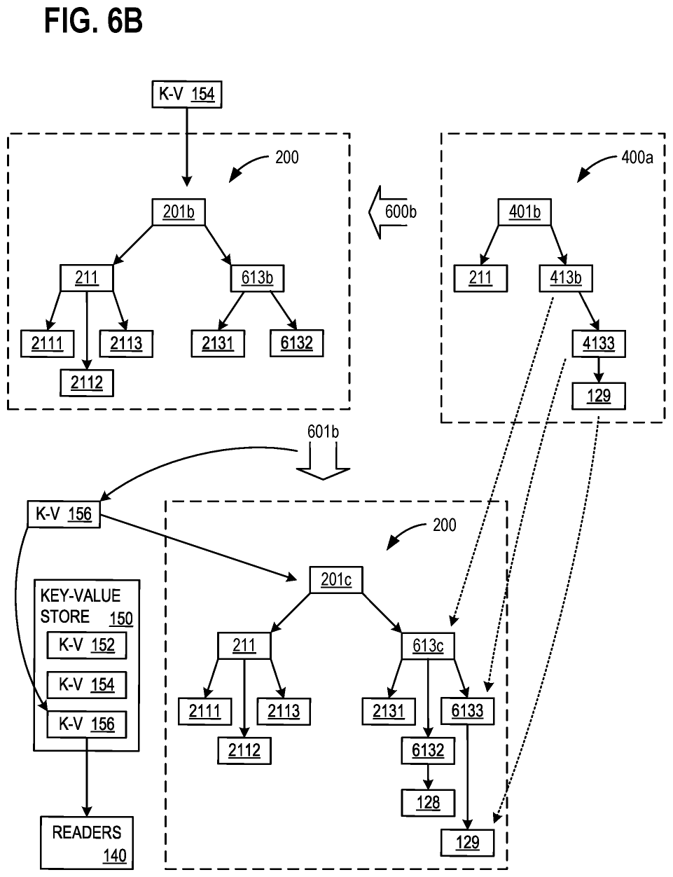

Returning to FIG. 1, branching is handled by branching manager 113, as illustrated in FIGS. 4, 6A and 6B. A snapshot manager 114 handles the generation of master branch snapshots 202a-202c. New master branches are created upon merging data from a private branch. A private branch is merged with the master branch when it contains data of committed transactions (e.g., a private branch cannot be merged with the master, if it contains data of an uncommitted transaction). There may be different policies used for merging private branches to the master branch. In some examples, as soon as a single transaction commits, the private branch on which the transaction was executed is merged with the master branch. In some examples, multiple transactions may commit in a private branch before that branch is merged to the master. In such examples, the merging occurs in response to one of the following triggers: (1) a timer 104 expires; (2) a resource monitor 106 indicates that a resources usage threshold T106 is met (e.g., available memory is becoming low). Other merge policies may also be implemented depending on the type of a transaction or the specification of a user. Also, merging may be performed in response to an explicit merge request by a client.

A commit creates a clean tree (e.g., tree data structure 210) from a dirty tree, transforming records into files with the tree directory structure. A merge applies a private branch to a master branch, creating a new version of the master branch. A flush persists a commit, making it durable, by writing data to persisted physical storage. Typically, master branches are flushed, although in some examples, private branches may also be flushed (in some scenarios). The order of events is: commit, merge, flush the master branch (the private branch is now superfluous), then update a crash recovery log cursor position. However, if a transaction is large, and exceeds available memory, a private branch may be flushed. This may be minimized to only occur when necessary, in order to reduce write operations.

Timer 104 indicates that a time limit has been met. In some scenarios, this is driven by a service level agreement (SLA) that requires data to become available to users by a time limit, specified in the SLA, after ingestion into the data lake or some other time reference. Specifying a staleness requirement involves a trade-off of the size of some data objects versus the time lag for access to newly ingested data. In general, larger data objects mean higher storage efficiency and query performance. If aggressive timing (e.g., low lag) is preferred, however, some examples allow for a secondary compaction process to compact multiple small objects into larger objects, while maintaining the write order. In some examples, resource monitor 106 checks on memory usage, and resource usage threshold T106 is a memory usage threshold or an available memory threshold. Alternatively, resources other than memory may be monitored.

Version control interface 110 atomically switches readers to a new master branch (e.g., switches from master branch snapshot 202a to master branch snapshot 202b or switches from master branch snapshot 202b to master branch snapshot 202c) after merging a private branch back into a master branch 200 (as shown in FIGS. 6A and 6B). Consistency is maintained during these switching events by moving all readers 140 from the prior master branch to the new master branch at the same time, so all readers 140 see the same version of data. To facilitate this, a key-value store 150 has a key-value entry for each master branch, as well as key-value entries for private branches. The key-value entries are used for addressing the root nodes of branches. For example, a key-value pair 152 points to a first version of master branch 200 (or master branch snapshot 202a), a key-value pair 154 points to a second version of master branch 200 (or master branch snapshot 202b, and a key-value pair 156 points to a third version of master branch 200 (or master branch snapshot 202c). In some examples, key-value store 150 is a distributed key-value store. In operation, key-value store 150 maps versions or snapshot heads to the node ID needed to traverse that version once it was committed and flushed.

A two-phase commit process, or protocol, which updates a key-value store 150, is used to perform atomic execution of writes when a group of tables, also known as data group, spans multiple servers and coordination between the different compute nodes is needed. Key-value store 150, which knows the latest key value pair to tag, facilitates coordination. Additionally, Each of readers 140 may use one of key-value pairs 152, 154, or 156 when time traveling (e.g., looking at data at a prior point in time), to translate a timestamp to a hash value, which will be the hash value for the master branch snapshot at that time point in time. A key-value store is a data storage paradigm designed for storing, retrieving, and managing associative arrays. Data records are stored and retrieved using a key that uniquely identifies the record and is used to find the associated data (values), which may include attributes of data associated with the key. The key-value store may be any discovery service. Examples of a key-value store include ETCD (which is an open source, distributed, consistent key-value store for shared configuration, service discovery, and scheduler coordination of distributed systems or clusters of machines), or other implementations using algorithms such as PAXOS, Raft and more.

There is a single instance of a namespace (master branch 200) for each group of tables, in order to implement multi-table transactions. In some examples, to achieve global consistency for multi-table transactions, read requests from readers 140 are routed through key-value store 150, which tags them by default with the current key-value pair for master branch 200 (or the most recent master branch snapshot). Time travel, described below, is an exception, in which a reader instead reads objects 121-129 from data lake 120 using a prior master branch snapshot (corresponding to a prior version of master branch 200).

Readers 140 are illustrated as including a reader 142, a reader 144, a reader 146, and a reader 148. Readers 142 and 144 are both reading from the most recent master branch, whereas readers 146 and 148 are reading from a prior master branch. For example, if the current master branch is the third version of master branch 200 corresponding to master branch snapshot 202c (pointed to by key-value pair 156), readers 142 and 144 use key-value pair 156 to read from data lake 120 using the third version of master branch 200 or master branch snapshot 202c. However, reader 146 instead uses key-value pair 154 to locate the root node of master branch snapshot 202b and read from there, and reader 148 uses key-value pair 152 to locate and read from master branch snapshot 202a. Time travel by readers 146 and 148 is requested using a time controller 108, and permits running queries as of a specified past date. Time controller 108 includes computer-executable instructions that permit a user to specify a date (or date range) for a search, and see that data as it had been on that date.

FIG. 3 illustrates further detail for data partitioning structure 300, which is captured by the hierarchical namespace of the overlay file system (version control interface 110). Partitioning is a prescriptive scheme for organizing tabular data in a data lake file system. Thus, data partitioning structure 300 has a hierarchical arrangement 310 with a root level folder 301 and a first tier with folders identified by a data category, such as a category_A folder 311, a category_B folder 312, and a category_C folder 313. Category_B folder 312 is shown with a second tier indicating a time resolution of years, such as a year-2019 folder 321, a year-2020 folder 322, and a year-2021 folder 323. Year-2020 folder 322 is shown with a third tier indicating a time resolution of months, such as a January (Jan) folder 331 and a February (Feb) folder 332. Feb folder 332 is shown as having data object 121 and data object 122. In some examples, pointers to data objects are stored in the contents of directory nodes.

The names of the folders leading to a particular object are path components of a path to the object. For example, stringing together a path component 302a (the name of root level folder 301), a path component 302b (the name of category_B folder 312), a path component 302c (the name of year-2020 folder 322), and a path component 302d (the name of Feb folder 332), gives a path 302 pointing to data object 121.

FIG. 4 illustrates generation of a private branch 400 from master branch 200, for example, using CoW. In some examples, when a private branch is checked out, a new snapshot is created. In general the process is that when adding something to data lake 120, a new snapshot is created. A copy of the data tree is made, starting with the root node, with the other portions pointing to the earlier tree. As each path is made dirty, that path is brought into memory, and the pointer is replaced with actual path data. Modifications may be made to the actual path data.

For clarity, node 212 and the leaf nodes under node 212 are not shown in FIG. 4. In a private branch generation process, root node 20, node 211, node 213, and reference 2131 of master branch 200 are copied as root node 401, node 411, node 413, and node 4131 of private branch 400, respectively. This is shown in notional view 410. Using CoW, in implementation view 420, it can be seen that node 411 is actually just a pointer to node 211 of master branch 200, and node 4131 is actually just a pointer to reference 2131 of master branch 200. Nothing below node 211 is copied, because no data in that branch (e.g., under node 211) is changed. Similarly, nothing below reference 2131 is copied, because no data in that branch is changed. Therefore, the hash values of node 211 and reference 2131 will not change.

However, new data is added under node 413, specifically a reference 413x that points to newly-added data object 12x (e.g., 128 or 129, as will be seen in FIGS. 6A and 6B). Thus, the hash values of node 413 will be different than the hash value of node 213, and the hash value of root node 401 will be different than the hash value of root node 201. However, until a merge process is complete, and readers are provided the new key-value pair for the post-merge master branch, none of readers 140 are able to see root node 401, node 403, node 403x, or data object 12x.

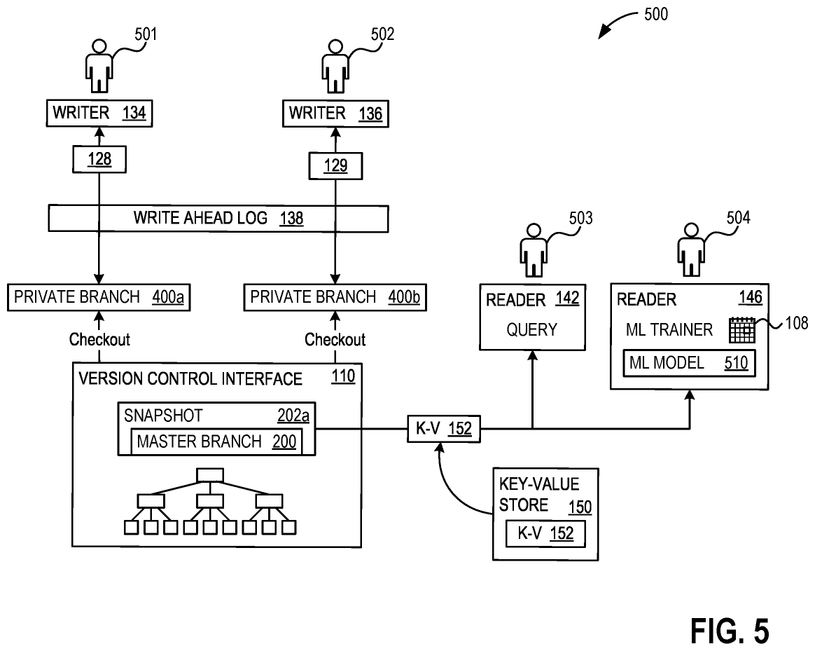

FIG. 5 illustrates a scenario 500 involving concurrent writing to private branches 400a and 400b by a plurality of writers (e.g., writers 134 and 136), while a plurality of readers (e.g., readers 142 and 146) concurrently read from master branch 200. Private branch 400a is checked out from version control interface 110 (copied from master branch snapshot 202a). Writer 134, operated by a user 501, writes data object 128, thereby updating private branch 400a. Similarly, private branch 400b is checked out from version control interface 110 (also copied from master branch snapshot 202a). Writer 136, for example operated by a user 502, writes data object 129, thereby updating private branch 400b. Writers 134 and 136 use WAL 138 for crash resistance. For example, when writers 134 and 136 check out private branches 400a and 400b from master branch 200 (by copying from master branch snapshot 202a), data objects 128 and 129 may be added by first writing to WAL 138 and then reading from WAL 138 to add data objects 128 and 129 to private branches 400a and 400b, respectively. This improves durability (of ACID).

While writers 134 and 136 are writing their respective data, readers 142 and 146 both use key-value pair 152 to access data in data lake 120 using master branch 200. While new transactions fork from master branch 200, some examples implement workspaces that permit both reads and writes. Prior to the merges of FIGS. 6A and 6B, neither reader 142 nor reader 146 is yet able to see either data object 128 or data object 129, even if both data objects 128 and 129 are already in data lake 120. As indicated in FIG. 5, reader 142, operated by a user 503, is performing a query (e.g., using a query language), and reader 146, operated by a user 504, is a machine learning (ML) trainer that is training an ML model 510, using time travel. For example, reader 146 may train ML model 510 using data from a time period back in time, and then assess the effectiveness of the training by providing more recent input into the ML model 510 and comparing the results (e.g., output) with current data (using the current master branch). This allows evaluation of the effectiveness, accuracy, etc. of the ML model 510.

As described above with reference to FIG. 1, version control interface 110 overlays multiple data lakes 120 (e.g., data lake 120 and data lake 120a), providing data federation (e.g., a process that allows multiple databases to function as a single database). Version control interface 110 leverages key-value (K-V) store 150 and metadata store 160 for managing access to the master branch. In some examples, multiple writers concurrently write to a private branch. In other examples, there is a one-to-one mapping of writers to private branches.

FIGS. 6A and 6B illustrate sequentially merging private branches 400a and 400b back into master branch 200. This is illustrated as merging private branch 400a into master branch 200, to produce a new version of master branch 200 (FIG. 6A) and then merging private branch 400b into master branch 200, to produce another new version of master branch 200 (FIG. 6B). When merging private branches, modified nodes of master branch 200 are re-written. The other nodes are overlaid from the previous version of master branch 200. The new root node of the master branch, with its unique hash signature, represents a consistent point-in-time snapshot of the state.

In the example of FIGS. 6A and 6B, data objects 128 and 129 are merged into the master branch. In some examples, compaction may occur here, if the number of the nodes changes due to data objects (e.g., parquet files) are being merged, and new data objects being generated. However, compaction is not required to commit. Aspects of the disclosure are operable with compaction or other implementations, such as interleaving existing data objects without merging.

In FIG. 6A, private branch 400a has a root node 401a, a node 413a, and a reference 4132 that points to data object 128, in a merge process 600a. The new root node of master branch 200 is root node 201b. Node 213, merged with node 413a, becomes node 613b, and reference 4132 is changed to reference 6132. Whereas node 213 had only reference 2131, node 613b has both reference 2131 and reference 6132. Key-value pair 152 points to root node 201a of master branch snapshot 202a, and remains in key-value store 150 for time travel purposes. However, as part of a transaction 601a, a new key-value pair 154 is generated that points to root node 201b of master branch snapshot 202b, and is available in key-value store 150. New key-value pair 154 is made available to readers 140 to read data object 128. The process to transition from one valid state to another follows a transaction process, one example of which is (1) allocate transaction ID, (2) flush all buffered updates for nodes traversable from 201b which include the transaction ID in their name, e.g., as a prefix, (3) add mapping of commit ID to location of 201b into key-value store 150 using a key-value store transaction. In the event of a roll-back, items with that transaction ID are removed.

In FIG. 6B, private branch 400b has a root node 401b, a node 413b, and a reference 4133 that points to data object 129, in a merge process 600b. The new root node of master branch 200, in master branch 200c is root node 201c. Node 613b, merged with node 413b, becomes node 613c, and reference 4133 is changed to reference 6133. Whereas node 613b had only references 2131 and 6132, node 613c has both references 2131, 6132, and also reference 6133. Key-value pair 154 points to root node 201b of master branch snapshot 202b, and remains in key-value store 150 for time travel purposes. However, as part of a transaction 601b, a new key-value pair 156 is generated that points to root node 201c of master branch snapshot 202c, and is available in key-value store 150. New key-value pair 156 is made available to readers 140 to read data object 129.

In some examples, to atomically switch readers from one master branch to another (e.g., from readers reading master branch snapshot 202a to reading master branch snapshot 202b), readers are stopped (and drained), the name and hash of the new master branch are stored in a new key-value pair, and the readers are restarted with the new key-value pair. Some examples do not stop the readers. For scenarios in which a group of tables is serviced by only a single compute node, there is lessened need to drain the readers when atomically updating the hash value of master branch 200 (which is the default namespace from which to read the current version (state) of data from data lake 120). However, draining of readers may be needed when two-phase commits are being used (e.g., when two or more servers service a group of tables). In such multi-node scenarios, readers are drained, stopped, key value store 150 is updated, and then readers resume with the new key value.

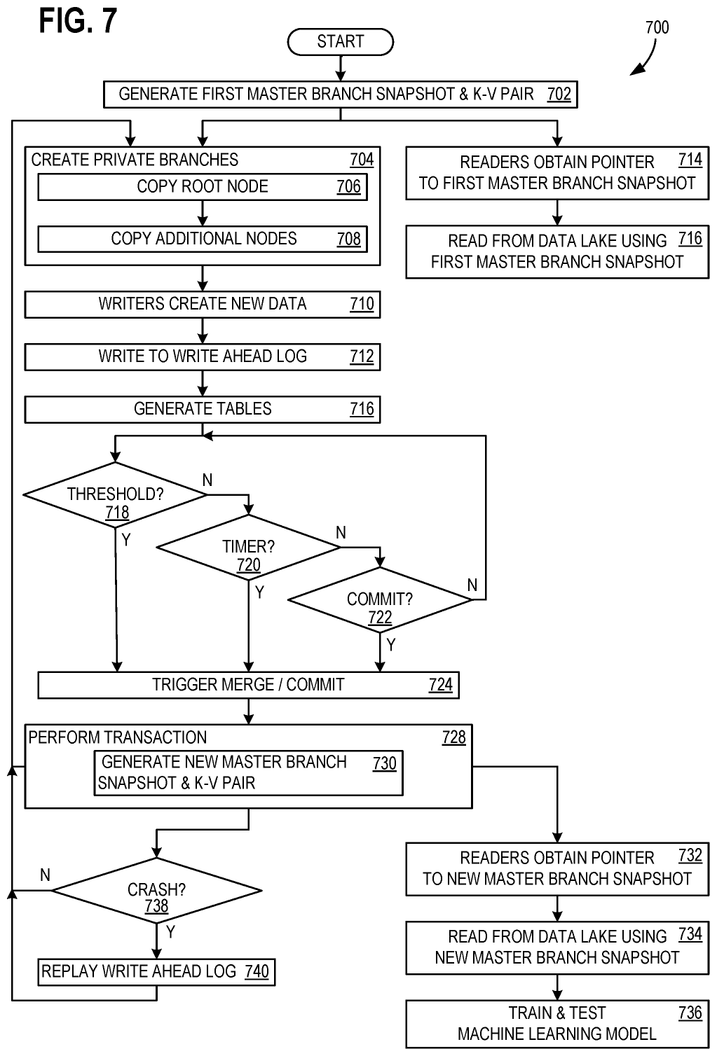

FIG. 7 illustrates a flowchart 700 of exemplary operations associated with architecture 100. In some examples, the operations of flowchart 700 are performed by one or more computing apparatus 1318 of FIG. 13. Flowchart 700 commences with operation 702, which includes generating master branch 200 for data objects (e.g., data objects 121-127) stored in data lake 120. Master branch 200 comprises tree data structure 210 having a plurality of leaf nodes (e.g., references 2111-2133) referencing the data objects. In some examples, tree data structure 210 comprises a hash tree. In some examples, tree data structure 210 comprises a Merkle tree. In some examples, non-leaf nodes of tree data structure 210 comprise path components for the data objects.

For each writer of a plurality of writers 130 (e.g., writers 134 and 136), operation 704 creates a private branch (e.g., private branches 400a and 400b) from a first version of master branch 200. Each private branch may be written to by its corresponding writer, but may be protected against writing by a writer different than its corresponding writer. In some examples, multiple writers access a single branch and implement synchronization to their branch server, rather than using global synchronization.

In some examples, a writer of the plurality of writers 130 comprises ingestion process 132. In some examples, ingestion process 132 receives data from data source 102a and writes data objects into data lake 120. Creating a private branch is performed using operations 706 and 708, which may be performed in response to an API call. Operation 706 includes copying a root node of tree data structure 210 of master branch 200. Operation 708, implementing CoW, includes creating nodes of the private branch based on at least write operations by the writer. In some examples this may include copying additional nodes of tree data structure 210 included in a path (e.g., path 302) to a data object being generated by a writer of the private branch. The additional nodes copied from tree data structure 210 into the private branch are on-demand creation of nodes as a result of write operations.

Writers create new data in the form of data objects 128 and 129 in operation 710. Operation 712 includes writing data to WAL 138. Writers perform write operations that are first queued into WAL 138 (written into WAL 138). Then the write operation is applied to the data which, in some examples, is accomplished by reading the write record(s) from WAL 138. Operation 714 includes generating a plurality of tables (e.g., tables 162-166) for data objects stored in data lake 120. In some examples, each table comprises a set of name fields and maps a space of columns or rows to a set of the data objects. In some examples, the data objects are readable by a query language. In some examples, ingestion process 132 renders the written data objects readable by a query language. In some examples, the query language comprises SQL. Some examples partition the tables by time. In some examples, partitioning information for the partitioning of the tables comprises path prefixes for data lake 120.

Operation 714 includes obtaining, by reader 142 and reader 146, the key-value pair pointing to master branch snapshot 202a and the partitioning information for partitioning the tables in metadata store 160. Operation 716 includes reading, by readers 140, the data objects from data lake 120 using references in master branch snapshot 202a. It should be noted that while operations 714 and 716 may start prior to the advent of operation 704 (creating the private branches), they continue on after operation 704, and through operations 710-714, decision operations 718-722, and operation 724. Only after operation 728 completes are readers 142 and 146 (and other for readers 140) able to read from data lake using a subsequent version of master branch 200 (e.g., master branch snapshot 202b or master branch snapshot 202c).

Decision operation 718 determines whether resource usage threshold T106 has been met. If so, flowchart 700 proceeds to operation 724. Otherwise, decision operation 720 determines whether timer 104 has expired. If so, flowchart 700 proceeds to operation 724. Otherwise, if a user commits a transaction, decision operation 722 determines that a user has committed a transaction. Lacking a trigger, flowchart returns to decision operation 718.

Operation 724 triggers a transactional merge process (e.g., transaction 601a or transaction 601b) on a writer of a private branch committing a transaction, a timer expiration, or a resource usage threshold being met. Operation 728 includes performing an ACID transaction comprising writing data objects. It should be noted that master branch snapshot 202a does not have references to the data objects written by the transaction. Such references are available only in subsequent master branches.

Operation 730 includes, for each private branch of the created private branches, for which a merge is performed, generating a new master branch for the data stored in data lake 120. For example, the second version of master branch 200 (master branch snapshot 202b) is the new master branch snapshot when master branch snapshot 202a had been current, and the third version of master branch 200 (master branch snapshot 202c) is the new master branch when master branch snapshot 202b had been current. Generating the new master branch comprises merging a private branch with the master branch. The new master branch references a new data object written to data lake 120 (e.g., master branch snapshot 202b references data object 128, and master branch snapshot 202c also references data object 129). In some examples, the new master branch is read-only. In some examples, operation 728 also includes performing a two-phase commit (2PC) process to update which version of master branch 200 (or which master branch snapshot) is the current one for reading and branching.

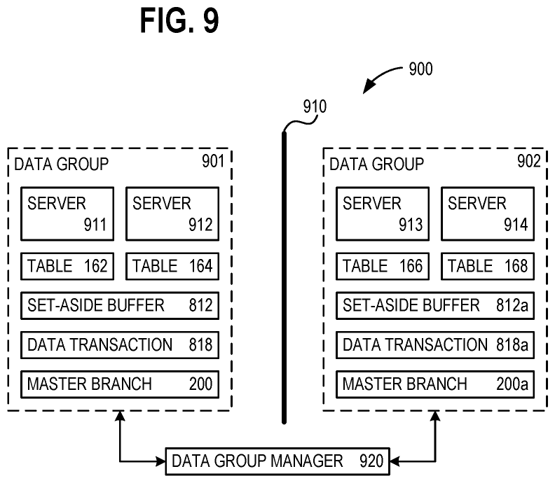

A 2PC is used for coordinating the execution of a transaction across more than one node. For example, if a data group has three tables A, B and C, and a first node performs operations (read/write) to two tables, while a second node performs operations to the third table, a 2PC may be used to execute a transaction that has operations to all three tables. This provides coordination between the two nodes. Either of the two nodes (or a different node) may host a transaction manager (see FIG. 9) that manages the 2PC.

Repeating operations 724-730 for other private branches generates a time-series (e.g., linked list 250) of master branches for data objects stored in data lake 120. In some examples, the time-series of master branches is not implemented as a linked list, but is instead stored in a database table. Each master branch includes a tree data structure having a plurality of leaf nodes referencing a set of the data objects. Each master branch is associated with a unique identifier and a time indication identifying a creation time of the master branch. The sets of the data objects differ for different ones of the master branches. Generating the time-series of master branches includes performing transactional merge processes that merge private branches into master branches.

After generating the new master branch, operation 732 includes obtaining, by reader 142 and reader 146, the key-value pair pointing to master branch snapshot 202b (e.g., key-value pair 154) and the partitioning information for partitioning the tables in metadata store 160. Operation 734 includes reading, by readers 140, the data objects from data lake 120 using references in the second version of master branch 200 (master branch snapshot 202b). Each of readers 140 is configured to read data object 128 using references in the first or second versions of master branch 200. Each of readers 140 is configured to read data object 129 using references in the third version of master branch 200 (master branch snapshot 202c), but not the first or second versions of master branch 200.

Flowchart 700 returns to operation 704 so that private branches may be created from the new master branch, to enable further writing by writers 130. However, one example of using a master branch to access data lake 120 with time travel is indicated by operation 736, which includes training ML model 510 with data objects read from data lake 120 using references in master branch snapshot 202a. Operation 736 also includes testing ML model 510 with data objects read from data lake 120 using references in master branch snapshot 202b. Crash resistance is demonstrated with operation 740, after decision operation 738 detects a crash. Operation 740 includes, based at least on recovering from a crash, replaying WAL 138.

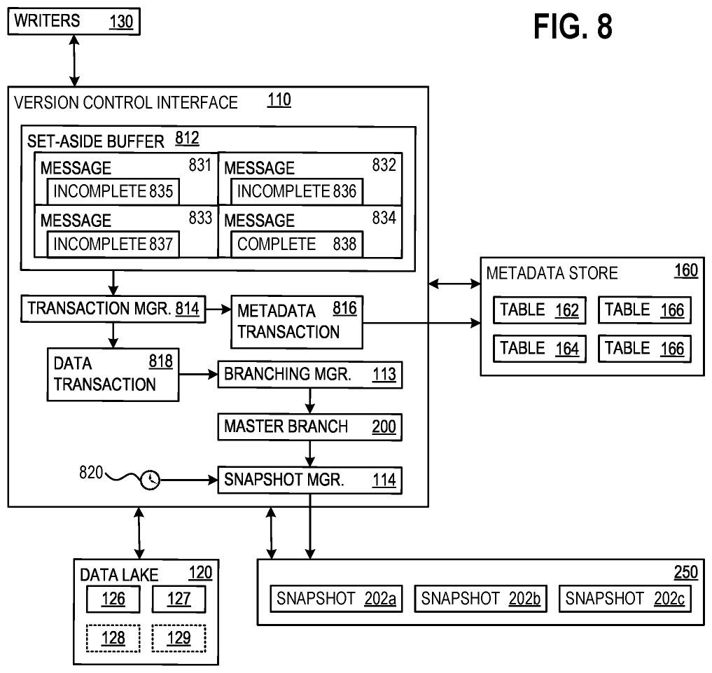

FIG. 8 illustrates using a set-aside (SA) buffer 812 to store messages 831-834 for a data transaction 818, using examples of architecture 100. Examples of architecture 100 use streaming transactions (STANs) that are sent in portions (e.g., as messages) until they are completed. A transaction may span multiple tables (e.g., data object 128 may span tables 162 and 163 or data object 129 may span tables 164 and 165) and may comprise multiple messages (e.g., messages 831-834). While a STAN is incomplete, the portions are held in SA buffer 812, which is an in-memory serialized table that performs batching of messages. This enables recovery of the in-memory state in the event of a crash. For example, recovery of the in-memory state is done by replaying WAL 138.

In some scenarios, a private branch is merged to the master branch due to memory pressure or a timer lapse (as opposed to a user-initiated commit), there may be insufficient time to complete transactions, resulting in incomplete transactions in SA buffer 812 that are not added to the private branch. Thus, SA buffer 812 and the checkpoint in WAL 138 are persisted. In the event of a crash, WAL 138 is rewound to the checkpoint for the replay.

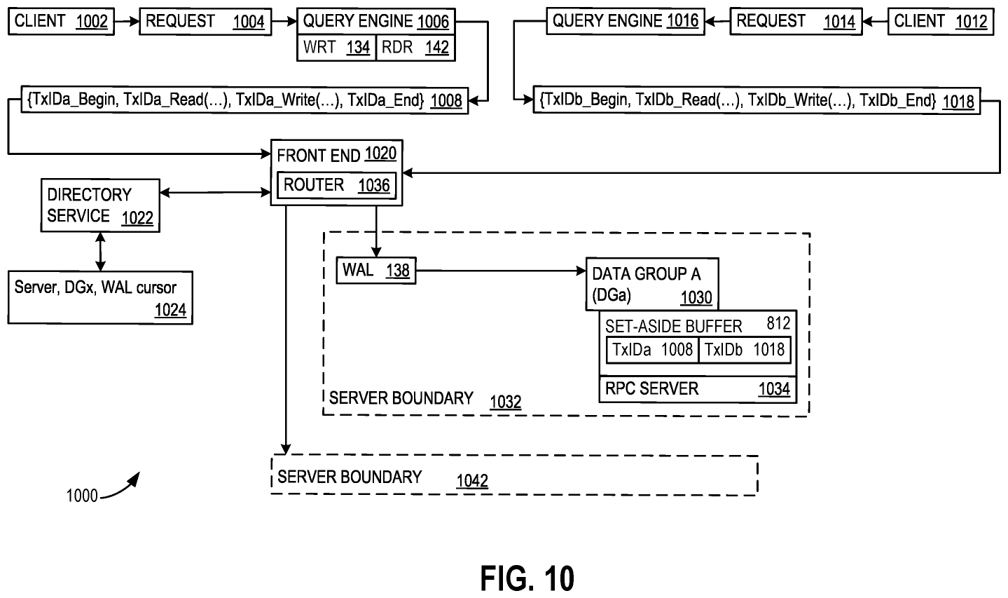

SA buffer 812 is used to buffer operations (e.g., messages 831-834) that are part of a single transaction, until the transaction is complete. This ensures atomicity. In some examples, SA buffer 812 is used for data ingestion, such as long-running data writing workloads that ingest large batches of data into data lake 120. In some examples, transaction begin/end are determined implicitly, so that each batch of ingested data retains ACID properties (e.g., with the batch defined as the data written by write operations between a set of begin/end operations, as shown in FIG. 10). In some examples, SA buffer 812 is used to implement small transactions that do not justify the creation of a private branch (e.g., only a few operations).

When a master branch snapshot is flushed, SA buffer 812 is written out. This ensures that the complete transactions are stored (e.g., in the flushed master branch), while incomplete transactions are stored in SA buffer 812. Thus, when recovering from a crash, it can be determined that SA buffer 812 had been written out. This will regenerate incomplete transactions. The remainder of messages from WAL 138 are then applied, potentially completing some transactions remaining within SA buffer 812. These newly-completed transactions are then applied to the master branch.

Upon recovery, the last safely written master branch is identified, which also includes the latest log sequence number (LSN) incorporated into a master branch snapshot, SA buffer 812 is reserialized, and messages are replayed starting with the associated LSN, completing recovery. An LSN is an incrementing value used for maintaining the sequence of a transaction log.

SA buffer 812 acts as a low-latency transactional log and provides atomicity by buffering streaming transactions until the transactions are complete. To ensure atomicity, incomplete transactions are not published. In comparison WAL 138 journals operations as messages prior to handling. Without journaling, if a crash occurs prior to an operation completing, the result will be an inconsistent state. Thus, in the event of a crash, WAL 138 is replayed from the most recent checkpointed version. Each message is assigned a unique LSN that is checkpointed as a reference for a potential replay of WAL 138.

When a new snapshot is flushed, SA buffer 812 is written out to ensure that complete transactions are stored (e.g., as part of a Merkle tree). When replaying WAL 138, SA buffer 812 is also read. This restores any incomplete transactions. Then, remaining messages in WAL 138 are applied, which may complete some of the transactions still in SA buffer 812. Any newly-completed transactions (from this replay) will be applied.

The combination of SA buffer 812 and key-value store 150 is additionally leveraged to implement atomicity of transactions. Partitioning features of popular messages buses (e.g., Kafka, Pravega) may be leveraged to automatically and dynamically map ingestion streams to provide high-throughput ingestion and load balancing. This allows for efficient, independent scaling of servers used to implement architecture 100.

Version control interface 110 receives incoming data from writers 130, which is written to the data lake as data objects. Incoming data arrives as messages, which are stored in a set-aside (SA) buffer 812 until the messages indicate that all of the data for a transaction has arrived (e.g., the transaction is complete). For example, incoming data arrives as message 831, followed by message 832, followed by message 833, and then followed by message 834. Message 831 contains both data and a complete/incomplete field 835 indicating incomplete (e.g., “complete=false”). Message 832 also contains both data and a complete/incomplete field 836 indicating incomplete. Message 833 also contains both data and a complete/incomplete field 837 indicating incomplete. Message 834 contains both data and a complete/incomplete field 838 indicating complete (e.g., “complete=true”).

When a transaction is started (e.g., writing data object 128 and/or 129), and a message arrives indicating that the transaction is incomplete, it is not yet added to the master branch. SA buffer 812 accumulates transaction-incomplete messages until a transaction-complete message (e.g., message 834) arrives. Committing a transaction updates the private branch on which the transaction executes. All of messages 831-834 are sent together as a complete transaction to update master branch 200. The private branch is merged to the master (public) branch for the results of one or more transactions to become visible to all readers.

A transaction manager 814 brings metadata management under same transaction domain as the data referred to by the metadata. Transaction manager 814 ensures consistency between metadata in metadata store 160 and data references in master branch snapshots, e.g., using two-phase commit and journaling in some examples. For example, a metadata transaction 816 is committed contemporaneously with a data transaction 818 to ensure consistency, updating both data and metadata atomically. This prevents disconnects between metadata in metadata store 160 and a master branch, in the event that an outage occurs when a new version of a master branch is being generated, rendering data lake 120 transactional. Metadata transaction 816 updates metadata in metadata store 160 and data transaction 818 is applied to a private branch and merged with master branch 200 to generate a new version of master branch 200 (see FIGS. 6A and 6B). Snapshot manager 114 handles the generation of master branch snapshots 202a-202c according to a scheduler 820. Master branch snapshots may be generated on a schedule, such as hourly, in response to a number of merges, and/or in response to a trigger event such as completing a commit of a large or important transaction.

FIG. 9 illustrates the use of data groups in a data group configuration 900, in examples of architecture 100. As noted previously, data lake 120 is represented in the form of a data tree (e.g., a structure), such as a Merkle tree, implemented on top of data storage. The data tree is stored in memory and persisted on storage. Each node in the data tree has an associated path component. For example, if a path (see FIG. 3) is path=bucket/table01/2022/02/28, the leaves of the tree are the files that hold the data, while branches represent the directory structure. In some examples, a leaf may be a parquet file. A tree snapshot (e.g., master branch snapshot) is a point in time for data lake 120. A tree structure facilitates certain functionality, such as versioning, for implementing transactions, time travel, and other features of version control interface 110.

As noted previously, transactions need to execute in a state that is immutable due to external factors (e.g., activities of other readers and writers) in a manner that is unaffected by external factors. Thus, there are different private branches for different transactions. Upon completion of the transaction (or another trigger) a commit is performed. Transactions operate on tables and table fields and may span multiple tables. If data spans multiple servers, the servers need to cooperate with each other. Data groups provide a solution to keeping the scope of commit operations manageable, permitting scaling to large data lakes.

Data groups are an abstraction, defined as a set of tables and a grouping of functional components (e.g., SA buffer 818, remote procedure call (RPC) servers 913 and 914, and others). Data groups qualify as schemas, which are collections of database objects, such as tables, that are associated with an owner or manager. In some examples, the data groups are fluid, with tables moving among different data groups, as needed—even during runtime. Data groups may be defined according to sets of tables that are likely to be accessed by the same transactions, and in some examples, a table may belong to only one data group at a time. Each data group has a master branch, and may have multiple private branches, simultaneously.

In some examples, data objects in data lake 120 may compose thousands of tables. A 2PC (or other commit process) over such a large number of tables may take a long time, because each server node must respond that it is ready. Separating (grouping) the tables into a plurality of smaller data groups reduces the time required for committing, because the number of server nodes is smaller (limited to a single data group) and the different data groups do not need to wait for the others. The scope of a transaction becomes that of a data group (set of tables). Using data groups, a few nodes may serve the transactions of each entire data group, thereby limiting the overhead of a 2PC. In some examples, a single node may handle the transactions to one or more data groups, precluding the need for a cross-node 2PC.

A trade-off for the time improvement is that transactions may not span data groups, in some examples. An atomicity boundary 910 between data group 901 and data group 902 provides a transactional boundary in terms of data consistency, meaning that master branch 200 of data group 901 is updated by data transaction 818, whereas a master branch 200a of data group 902 is separately updated by a data transaction 818a. Data groups 901 and 902 support streaming transaction so each has its own SA buffer.

Data group configuration 900 is configurable in terms of which tables belong to which data group, and may be modified (reconfigured) at runtime (e.g., during execution). That is, the set of tables that form a data group may be modified during runtime. A table may belong to at most one group at any point in time. In the illustrated example, data group 901 spans two servers, server 911 and server 912, although in some examples, a single server node may host multiple data groups (e.g., elements of data groups or even complete data groups). Data group 901 is shown as having two tables, table 162 and 164, although some examples may use thousands of tables per data group. Data group 901 also has SA buffer 812 and is served by master branch 200. Data transaction 818 is limited to tables within data group 901. Similarly, data group 902 spans two server nodes, server 913 and server 914, and is shown as having two tables, table 162 and 164. Servers 913 and 914 are responsible for private branches, and each may be responsible for more than a single table (e.g., more than just a single one of table 166 or 168). Data group 902 has a SA buffer 812a and is served by master branch 200a. Data transaction 818a is limited to tables within data group 902.

Because of atomicity boundary 910, during a 2PC for one of data groups 901, both reading and writing operations may continue in the other data group. A data group manager 920 manages data group configuration (e.g., determining which table is within which data group), and is able to modify data group configuration 900 during runtime (e.g., reassigning or moving tables among data groups).

FIG. 10 illustrates an arrangement 1000, which shows how data flows through various components of architecture 100. A client 1002 (e.g., user 501) makes a request 1004 of a query engine 1006 (e.g., writer 134 or reader 142), which produces a set of messages 1008 (e.g., messages 831-834). Query engine 1006 translates request 1004 into a sequence of read and write operations that are tagged with a unique transaction identifier (TxID). Set of messages 1008 belongs to a transaction A and has a Begin (TxIDa_Begin) and End (TxIDa_End) set that demarcates the beginning and end of the transaction. Each message within transaction A is also identified (tagged) with the transaction identifier (TxIDa) that identifies the message as being part of transaction A.

Similarly, a client 1012 makes a request 1014 of a query engine 1016, which produces a set of messages 1018. Set of messages 1018 belongs to a transaction B and has a Begin (TxIDb_Begin) and End (TxIDb_End) set that demarcates the beginning and end of the transaction. Each message within transaction B is also identified (tagged) with the transaction identifier (TxIDb) that identifies the message as being part of transaction B.

The messages from both transactions arrive at a front end 1020 that uses a directory service 1022 (e.g., ETCD) to route the messages to the proper data group. Directory service 1022 stores data group information 1024 that includes the server, the data group tag (“DGx”, which may be DGa as noted in the figure), and a WAL cursor location. Each data group has its own data group information 1024 in directory service 1022. In the illustrated example, both transaction A and transaction B are routed to data group 1030, identified as data group A with the identifier DGa, and which represents data group 901 of FIG. 9. A server boundary 1032 defines the extent of the schema of data group 1030. A similar server boundary 1042 defines the extent of the schema of another data group data group, such as data group 902.

Router 1036 uses the TxID to sort incoming messages by transaction and locates the data groups using directory service 1022. When a transaction arrives at a data group, the data group will journal it to WAL 138, to make it durable. SA buffer 812 is used for streaming transactions, but not used for SQL transactions. When a new streaming transaction arrives, a new private branch is created to handle that transaction. Branches (e.g., master branches and private branches) are managed by RPC servers that perform reads (e.g., return read results), and each RPC server has its own tree (e.g., a master or private branch tree). This enables independent operation of the RPC servers. Data group 1030 uses an RPC server 1034. Since data group 1030 is receiving both transaction A and transaction B (set of messages 1008 and set of messages 1018), two private branches are needed. In some examples, there is a one-to-one mapping of RPC servers and branches, meaning that two workspace branches (in this described example) requires two RPCServers.

In another scenario, set of messages 1008 and set of messages 1018 represent SQL transactions. These messages are sent to front end 1020, which includes a router 1036 that uses directory service 1022 (e.g., ETCD) to locate the datagroup for each transaction. Router 1036 uses the TxID to sort incoming messages by transaction and sends the messages of a transaction to the appropriate data group 1030. Data group 1030 first journals the transaction to WAL 138 and then starts applying the transaction messages. To ensure atomicity, datagroup 1030 forks a new branch called workspace branch and applies the transaction messages to this branch. A workspace branch is managed by an RPC server 1034, similarly to a private branch. One difference between a workspace branch and a private branch is that a workspace branch is read-write while a private branch is read-only. The workspace branch is used to buffer an incomplete transaction, read in the context of the transaction, and then either commit or roll back the transaction. In some examples, only a single transaction is mapped to a workspace branch, unlike private branches (to which multiple transactions may be mapped). When the transaction is completed by receiving TxIDx_End, the workspace branch is merged with the master branch and is published on directory service 1022 so that the results of the transaction become available for reading outside the context of the transaction.

Incoming read/write operations are converted to use the paths of the tree structure to reach the specific data files. If a write operation creates a new node, it is added to the data tree at this time. If a new transaction (e.g., TxIDb_Begin) arrives when an earlier transaction is still ongoing, a new private branch is spawned. When a transaction completes (e.g., TxIDa_End arrives) a commit is started, the private branch back is merged into the master branch (e.g., master branch 200—see FIG. 6A). The master branch is persisted, key value store 150 is updated, WAL 138 is written out, and the WAL cursor in data group information 1024 is updated. In some examples, WAL 138 services multiple data groups with one channel for each data group (with each channel having its own cursor). In such examples, when there is a crash or other event requiring recovery, the corresponding WAL channel is the one that is replayed. WAL cursor update follows the persisting of the master branch, in the event that a crash occurs while persisting the master branch.

In addition to the explicit transactions, some examples also support implicit transactions, for example when clients do not use a query engine that performs a translation and adds Begin and End messages. In such examples, artificial transactional boundaries are used to bound the number of transactional operations. For example, front end 1020 creates its own Begin and End messages based on some trigger criteria. Example trigger criteria includes a timer lapse and a count of operations reaching a threshold number. Some examples use SA buffer 812 to add more than a transaction to a private branch. In some examples, this improves efficiency. For SQL transactions (including implicit transactions) SA buffer 812 is not used, and instead the transaction is applied directly to a workspace branch.

When two or more private branches modify the same branch of the tree structure of a master branch, a policy may be needed to handle potential conflicts. The policies may vary by data group, because different policies may be preferable for different types of workflows. Possible policies include that the first private branch to merge wins, the final private branch to merge wins, and that snapshot isolation provides complete invisibility.

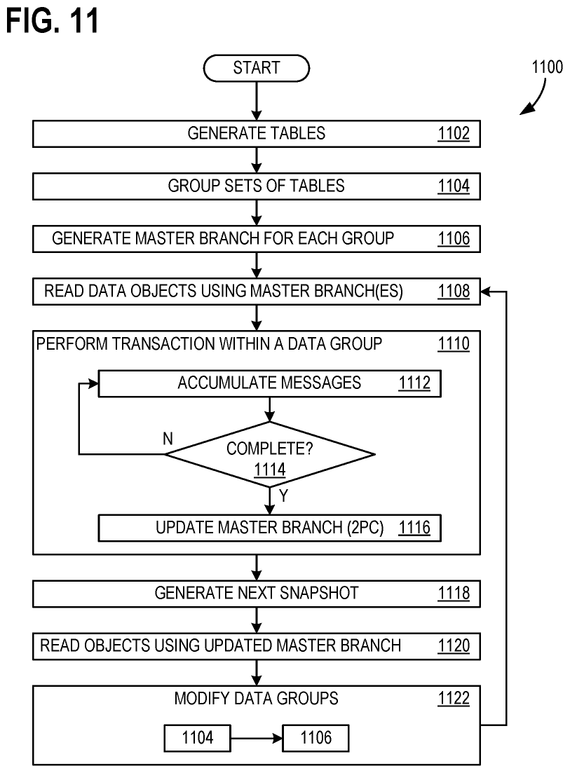

FIG. 11 illustrates a flowchart 1100 of exemplary operations that are also associated with architecture 110. In some examples, the operations of flowchart 1100 are performed by one or more computing apparatus 1318 of FIG. 13. Flowchart 1100 commences with operation 1102, which generates a plurality of tables (e.g., tables 162-166) for data objects (e.g., data objects 121-129) stored in data lake 120. Each table comprises a set of name fields and maps a space of columns or rows to a set of the data objects. In some examples, the data objects are readable by a query language (e.g., SQL), because the ingestion process renders the written data objects readable by the query language.

Operation 1104 groups sets of the plurality of tables into a plurality of data groups (e.g., data groups 901 and 902), and operation 1106 generates a first version of master branch 200 and a first master branch snapshot (e.g., master branch snapshot 202a) for the first version of master branch 200. In some examples, master branch snapshot 202a comprises a tree data structure (e.g., a hash tree, such as a Merkle tree) having a plurality of leaf nodes referencing the data objects. Non-leaf nodes of the data structure comprise path components for the data objects. In operation 1108, a plurality of readers read data objects from data lake 120 using references in master branch snapshot 202a. In some examples, master branch snapshot 202a is read-only, and does not have references to data objects written by any transaction that is not yet complete (e.g., the transaction of operation 1110).

Operation 1110, which is accomplished using operations 1112-1116, performs an ACID transaction (e.g. data transaction 818) comprising reading and/or writing data objects spanning a plurality of tables. The transaction is limited to tables within a single data group, to enforce atomicity boundary 910. Operation 1112 accumulates messages 831-834 in SA buffer 812 (for streaming transactions), for example, accumulating transaction-incomplete messages 831-833, indicating that the transaction is incomplete, until transaction-complete message 834 is received, indicating that the transaction is complete. In some examples, SA buffer 812 is a serialized table. In some examples, SA buffer 812 is not used when transactions are not streaming. Decision operation 1114 determines whether the accumulated messages are complete. If not, flowchart 1100 returns to operation 1112 to further accumulate messages.

Based on at least receiving transaction-complete message 834, flowchart 1100 moves to operation 1116 to update master branch 200 to referencing the data objects according to received transaction-incomplete messages 831-833 and transaction-complete message 834. In some examples, updating master branch 200 comprises performing a 2PC process. Upon completion of operation 1110 (e.g., subsequent to performing the transaction), operation 1118 generates another (new) version of master branch 200 and a second master branch snapshot (e.g., master branch snapshot 202a) for the new version of master branch 200. In operation 1120, a plurality of readers read data objects from data lake 120 using references in master branch snapshot 202b. Master branch snapshot 202b (and the new version of master branch 200) have references to the data objects (e.g., data object 128 and/or 129) written by the transaction of operation 1110, enabling the readers to read the new data objects.

In operation 1122 data group manager 920 modifies data group configuration 900 during runtime, which includes performing versions of operations 1104 and 1106. Flowchart 1100 then returns to operation 1108, in which the readers are able to read objects using master branches of the modified data groups. A parallel version of flowchart 1100 is able to perform a transaction comprising writing data objects spanning a plurality of tables within a different data group. The different data groups may each perform their own versions of flowchart 1100 independently (except for the reconfiguration of operation 1122).

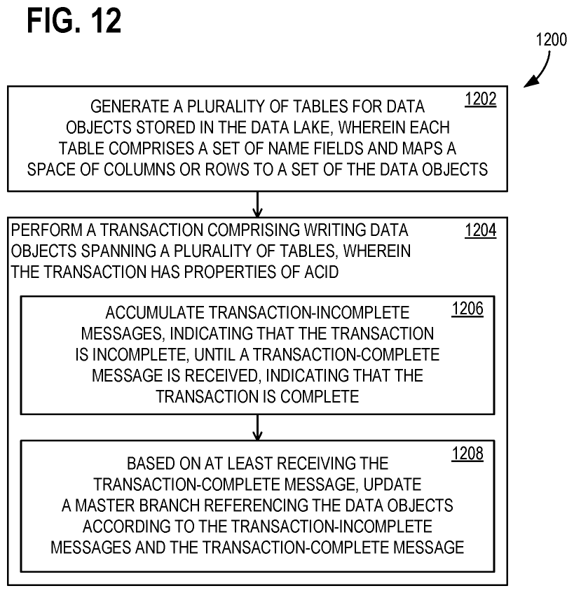

FIG. 12 illustrates a flowchart 1200 of exemplary operations that are also associated with architecture 100. In some examples, the operations of flowchart 1200 are performed by one or more computing apparatus 1318 of FIG. 13. Flowchart 1200 commences with operation 1202, which includes generating a plurality of tables for data objects stored in the data lake, wherein each table comprises a set of name fields and maps a space of columns or rows to a set of the data objects.

Operation 1204 includes performing a transaction comprising writing data objects spanning a plurality of tables, wherein the transaction has properties of ACID. Performing the transaction in operation 1204 is accomplished using operations 1206 and 1208. Operation 1206 includes accumulating transaction-incomplete messages, indicating that the transaction is incomplete, until a transaction-complete message is received, indicating that the transaction is complete. Operation 1208 includes, based on at least receiving the transaction-complete message, updating a master branch referencing the data objects according to the transaction-incomplete messages and the transaction-complete message.

### ADDITIONAL EXAMPLES

An example method comprises: generating a plurality of tables for data objects stored in the data lake, wherein each table comprises a set of name fields and maps a space of columns or rows to a set of the data objects; and performing a transaction comprising writing data objects spanning a plurality of tables, wherein the transaction has properties of ACID, and wherein performing the transaction comprises: accumulating transaction-incomplete messages, indicating that the transaction is incomplete, until a transaction-complete message is received, indicating that the transaction is complete; and based on at least receiving the transaction-complete message, updating a master branch referencing the data objects according to the transaction-incomplete messages and the transaction-complete message.

An example computer system providing a version control interface for accessing a data lake comprises: a processor; and a non-transitory computer readable medium having stored thereon program code executable by the processor, the program code causing the processor to generate a plurality of tables for data objects stored in the data lake, wherein each table comprises a set of name fields and maps a space of columns or rows to a set of the data objects; and perform a transaction comprising writing data objects spanning a plurality of tables, wherein the transaction has properties of ACID, and wherein performing the transaction comprises: accumulating transaction-incomplete messages, indicating that the transaction is incomplete, until a transaction-complete message is received, indicating that the transaction is complete; and based on at least receiving the transaction-complete message, updating a master branch referencing the data objects according to the transaction-incomplete messages and the transaction-complete message.

An example non-transitory computer storage medium has stored thereon program code executable by a processor, the program code embodying a method comprising: generating a plurality of tables for data objects stored in the data lake, wherein each table comprises a set of name fields and maps a space of columns or rows to a set of the data objects; and performing a transaction comprising writing data objects spanning a plurality of tables, wherein the transaction has properties of ACID, and wherein performing the transaction comprises: accumulating transaction-incomplete messages, indicating that the transaction is incomplete, until a transaction-complete message is received, indicating that the transaction is complete; and based on at least receiving the transaction-complete message, updating a master branch referencing the data objects according to the transaction-incomplete messages and the transaction-complete message.

Alternatively, or in addition to the other examples described herein, examples include any combination of the following:
grouping sets of the plurality of tables into a plurality of data groups;
each data group comprises multiple tables;
the transaction comprises a first transaction limited to tables within a first data group;
performing a second transaction comprising writing data objects spanning a plurality of tables within a second data group;
modifying data group configurations during runtime;
prior to performing the transaction, generating a first master branch snapshot for the master branch;
the first master branch snapshot comprises a tree data structure having a plurality of leaf nodes referencing the data objects;
prior to performing the transaction, reading, by a plurality of readers, the data objects from the data lake using references in the first master branch snapshot;
subsequent to performing the transaction, generating a second master branch snapshot for the master branch;
the second master branch snapshot comprises a tree data structure having a plurality of leaf nodes referencing the data objects;
subsequent to performing the transaction, reading, by the plurality of readers, the data objects from the data lake using references in the second master branch snapshot;
the second master branch snapshot has references to the data objects written by the transaction;
performing a 2PC process;
based at least on recovering from a crash, replaying the WAL;
accumulating the transaction-incomplete messages comprises accumulating the transaction-incomplete messages in a serialized table;
the first master branch snapshot does not have references to the data objects written by the transaction;
each transaction is limited to a single data groups to enforce an atomicity boundary;
the first master branch snapshot is read-only;
the second master branch snapshot is read-only;
the data structure comprises a hash tree;
the data structure comprises a Merkle tree;
non-leaf nodes of the data structure comprise path components for the data objects;
the data objects are readable by a query language; and
the ingestion process renders the written data objects readable by a query language;
the query language comprises SQL.

### Exemplary Operating Environment

The present disclosure is operable with a computing device (computing apparatus) according to an embodiment shown as a functional block diagram 1300 in FIG. 13. In an embodiment, components of a computing apparatus 1318 may be implemented as part of an electronic device according to one or more embodiments described in this specification. The computing apparatus 1318 comprises one or more processors 1319 which may be microprocessors, controllers, or any other suitable type of processors for processing computer executable instructions to control the operation of the electronic device. Alternatively, or in addition, the processor 1319 is any technology capable of executing logic or instructions, such as a hardcoded machine. Platform software comprising an operating system 1320 or any other suitable platform software may be provided on the computing apparatus 1318 to enable application software 1321 to be executed on the device. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 1318. Computer-readable media may include, for example, computer storage media such as a memory 1322 and communications media. Computer storage media, such as a memory 1322, include volatile and non-volatile, removable, and non-removable media implemented in any method or technology for storage of information such as computer readable instructions, data structures, program modules or the like. In some examples, computer storage media are implemented in hardware. Computer storage media include, but are not limited to, RAM, ROM, EPROM, EEPROM, persistent memory, non-volatile memory, phase change memory, flash memory or other memory technology, compact disc (CD, CD-ROM), digital versatile disks (DVD) or other optical storage, floppy drives, hard disks, magnetic cassettes, magnetic tape, magnetic disk storage, shingled disk storage or other magnetic storage devices, or any other non-transmission medium that can be used to store information for access by a computing apparatus. Computer storage media are tangible, non-transitory, and are mutually exclusive to communication media.

In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (memory 1322) is shown within the computing apparatus 1318, it will be appreciated by a person skilled in the art, that the storage may be distributed or located remotely and accessed via a network or other communication link (e.g. using a communication interface 1323).

The computing apparatus 1318 may comprise an input/output controller 1324 configured to output information to one or more output devices 1325, for example a display or a speaker, which may be separate from or integral to the electronic device. The input/output controller 1324 may also be configured to receive and process an input from one or more input devices 1326, for example, a keyboard, a microphone, or a touchpad. In one embodiment, the output device 1325 may also act as the input device. An example of such a device may be a touch sensitive display. The input/output controller 1324 may also output data to devices other than the output device, e.g. a locally connected printing device. In some embodiments, a user may provide input to the input device(s) 1326 and/or receive output from the output device(s) 1325.

The functionality described herein can be performed, at least in part, by one or more hardware logic components. According to an embodiment, the computing apparatus 1318 is configured by the program code when executed by the processor 1319 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A method of accessing a data lake, the method comprising:
generating a plurality of tables for data objects stored in the data lake, wherein each table comprises a set of name fields and maps a space of columns or rows to a set of the data objects; and
performing a transaction comprising reading and writing data objects spanning a plurality of tables, wherein the transaction has properties of atomicity, consistency, isolation, durability (ACID), and wherein performing the transaction comprises:
accumulating transaction-incomplete messages, indicating that the transaction is incomplete, until a transaction-complete message is received, indicating that the transaction is complete; and
based on at least receiving the transaction-complete message, updating a master branch referencing the data objects according to the transaction-incomplete messages and the transaction-complete message.

2. The method of claim 1, further comprising:
grouping sets of the plurality of tables into a plurality of data groups, each data group comprising multiple tables, wherein the transaction comprises a first transaction limited to tables within a first data group.

3. The method of claim 2 further comprising:
performing a second transaction comprising writing data objects spanning a plurality of tables within a second data group.

4. The method of claim 2, further comprising:
modifying data group configurations during runtime.

5. The method of claim 1, further comprising:
prior to performing the transaction:
generating a first master branch snapshot for the master branch, the first master branch snapshot comprising a tree data structure having a plurality of leaf nodes referencing the data objects; and
reading, by a plurality of readers, the data objects from the data lake using references in the first master branch snapshot; and
subsequent to performing the transaction:
generating a second master branch snapshot for the master branch, the second master branch snapshot comprising a tree data structure having a plurality of leaf nodes referencing the data objects; and
reading, by the plurality of readers, the data objects from the data lake using references in the second master branch snapshot, wherein the second master branch snapshot has references to the data objects written by the transaction.

6. The method of claim 1, further comprising:
performing a two-phase commit (2PC) process.

7. The method of claim 1, further comprising:
based at least on recovering from a crash, replaying a write-ahead log (WAL).

8. The method of claim 1, wherein accumulating the transaction-incomplete messages comprises:
accumulating the transaction-incomplete messages in a serialized table.

9. A computer system for accessing a data lake, the computer system comprising:
a processor; and
a non-transitory computer readable medium having stored thereon program code executable by the processor, the program code causing the processor to:
generate a plurality of tables for data objects stored in the data lake, wherein each table comprises a set of name fields and maps a space of columns or rows to a set of the data objects; and
perform a transaction comprising reading and writing data objects spanning a plurality of tables, wherein the transaction has properties of atomicity, consistency, isolation, durability (ACID), and wherein performing the transaction comprises:
accumulating transaction-incomplete messages, indicating that the transaction is incomplete, until a transaction-complete message is received, indicating that the transaction is complete; and
based on at least receiving the transaction-complete message, updating a master branch referencing the data objects according to the transaction-incomplete messages and the transaction-complete message.

10. The computer system of claim 9, wherein the program code is further operative to:
group sets of the plurality of tables into a plurality of data groups, each data group comprising multiple tables, wherein the transaction is limited to tables within a single data group; and
perform a second transaction comprising writing data objects spanning a plurality of tables within a second data group.

11. The computer system of claim 10, wherein the program code is further operative to:
modify data group configurations during runtime.

12. The computer system of claim 9, wherein the program code is further operative to:
prior to performing the transaction:
generate a first master branch snapshot for the master branch, the first master branch snapshot comprising a tree data structure having a plurality of leaf nodes referencing the data objects; and
read, by a plurality of readers, the data objects from the data lake using references in the first master branch snapshot; and
subsequent to performing the transaction:
generate a second master branch snapshot for the master branch, the second master branch snapshot comprising a tree data structure having a plurality of leaf nodes referencing the data objects; and
read, by the plurality of readers, the data objects from the data lake using references in the second master branch snapshot, wherein the second master branch snapshot has references to the data objects written by the transaction.

13. The computer system of claim 9, wherein the program code is further operative to:
perform a two-phase commit (2PC) process.

14. The computer system of claim 9, wherein the program code is further operative to:
based at least on recovering from a crash, replay the WAL.

15. The computer system of claim 9, wherein accumulating the transaction-incomplete messages comprises:
accumulating the transaction-incomplete messages in a serialized table.

16. A non-transitory computer storage medium having stored thereon program code executable by a processor, the program code embodying a method comprising:
generating a plurality of tables for data objects stored in the data lake, wherein each table comprises a set of name fields and maps a space of columns or rows to a set of the data objects; and
performing a transaction comprising reading and writing data objects spanning a plurality of tables, wherein the transaction has properties of atomicity, consistency, isolation, durability (ACID), and wherein performing the transaction comprises:
accumulating transaction-incomplete messages, indicating that the transaction is incomplete, until a transaction-complete message is received, indicating that the transaction is complete; and
based on at least receiving the transaction-complete message, updating a master branch referencing the data objects according to the transaction-incomplete messages and the transaction-complete message.

17. The computer storage medium of claim 16, wherein the program code method further comprises:
grouping sets of the plurality of tables into a plurality of data groups, each data group comprising multiple tables, wherein the transaction comprises a first transaction limited to tables within a first data group; and
performing a second transaction comprising writing data objects spanning a plurality of tables within a second data group.

18. The computer storage medium of claim 16, wherein the program code method further comprises:
modifying data group configurations during runtime.

19. The computer storage medium of claim 16, wherein the program code method further comprises:
prior to performing the transaction:
generating a first master branch snapshot for the master branch, the first master branch snapshot comprising a tree data structure having a plurality of leaf nodes referencing the data objects; and
reading, by a plurality of readers, the data objects from the data lake using references in the first master branch snapshot; and
subsequent to performing the transaction:
generating a second master branch snapshot for the master branch, the second master branch snapshot comprising a tree data structure having a plurality of leaf nodes referencing the data objects; and
reading, by the plurality of readers, the data objects from the data lake using references in the second master branch snapshot, wherein the second master branch snapshot has references to the data objects written by the transaction.

20. The computer storage medium of claim 16, wherein the program code method further comprises:
based at least on recovering from a crash, replaying the WAL.
